(19) United States
(12) Patent Application Publication
(10) Pub. No.: US 2014/0243083 A1
(43) Pub. Date: Aug. 28, 2014

(54) APPARATUS AND METHOD OF PROVIDING CLOUD SERVICE USING GAME PLATFORM BASED ON STREAMING

(71) Applicant: ELECTRONICS AND TELECOMMUNICATIONS RESEARCH INSTITUTE, Daejeon (KR)

(72) Inventors: Su Young BAE, Daejeon (KR); Chang Sik CHO, Daejeon (KR); Hun Joo LEE, Daejeon (KR); Kyoung Il KIM, Seoul (KR)

(21) Appl. No.: 14/150,817

(22) Filed: Jan. 9, 2014

(30) Foreign Application Priority Data
Feb. 27, 2013 (KR) 10-2013-0020960

(51) Int. Cl. A63F 13/30

(52) U.S. Cl. CPC A63F 13/12
USPC 463/31

(57) ABSTRACT

Provided is an apparatus and a method of providing a cloud service, the apparatus including an allocation unit to allocate a streaming service providing a service to a user terminal corresponding to a service request for manipulating game content received from the user terminal, a controller to control the game content of the allocated streaming server based on the service request, and a providing unit to stream and provide a result screen of the controlled game content to the user terminal, wherein the controller controls the game content of the allocated streaming server based on a service request re-received from the user terminal provided with the result screen.

### CROSS-REFERENCE TO RELATED APPLICATION

This application claims the priority benefit of Korean Patent Application No. 10-2013-0020960, filed on Feb. 27, 2013, in the Korean Intellectual Property Office, the disclosure of which is incorporated herein by reference.

### BACKGROUND

1. Field of the Invention

The present invention relates to an apparatus and a method of providing a cloud service using a game platform based on streaming, and more particularly, to an apparatus for providing a cloud service that controls a user interface of a streaming server based on a service request from a user and provides a result screen of control to the user.

2. Description of the Related Art

Streaming-based multiplatform supporting cloud service technology includes a large scale of cloud nodes. A cloud service is driven in real time on cloud nodes according to an application program which needs high-performance game or rendering. Cloud service technology enables an image driven on the cloud nodes to be transmitted to a variety of user terminals via a network. Here, cloud service technology employs a streaming method to transmit the image to the user terminals. The cloud service is immediately transmitted to the cloud nodes upon a user input that occurs on a user terminal and driven in real time.

Such a streaming-based cloud service provides high-quality applications on a user terminal without installation of additional equipment. The cloud service installs an application program requiring high performance on a cloud server, not on a user terminal, enabling the user to efficiently use the application regardless of performance. Further, the cloud service eases upgrading since patching and upgrading the installed application program are performed on a cloud node. In addition, the cloud service does not involve a risk of illegal copy.

However, the streaming-based cloud service has a low reaction speed as compared with an application implemented on a local system, because a time delay occurs when the streaming server encodes and transmits a driven screen. Further, the cloud service lacks a data compression technique and a network bandwidth for providing a high-quality image service.

In addition, the cloud service needs technology for processing an input device commonly used in various input environments of user terminals so as to conduct a user input with respect to a transmitted image.

### SUMMARY

An aspect of the present invention provides a cloud service providing apparatus enabling efficient use of cloud computing on a user terminal with low specifications by minimizing delays in encoding, decoding and networking of an image so as to provide a service on streaming-based high-performance content in real time.

Another aspect of the present invention also provides a cloud service providing apparatus which provides an exclusive input interface for use of game content requiring high-performance graphics and rendering on a user terminal with low specifications, thereby conveniently utilizing the game content on user terminals including different interfaces without an additional device.

Still another aspect of the present invention also provides a cloud service providing apparatus which provides a streaming-based cloud server to be applied to a user terminal with low specifications, thereby enabling a single platform-based application service to be available on various platforms.

Yet another aspect of the present invention also provides a cloud service providing apparatus which installs an application program of a game platform used by a user on a streaming server, not on a user terminal, thereby efficiently providing a streaming-based service regardless of performance.

According to an aspect of the present invention, there is provided an apparatus for providing a cloud service, the apparatus including an allocation unit to allocate a streaming service providing a service to a user terminal corresponding to a service request for manipulating game content received from the user terminal, a controller to control the game content of the allocated streaming server based on the service request, and a providing unit to stream and provide a result screen of the controlled game content to the user terminal, wherein the controller controls the game content of the allocated streaming server based on a service request re-received from the user terminal provided with the result screen.

The allocation unit may allocate a streaming server including an application program used to manipulate the game content.

The service request may include an input event from a user for manipulating the game content based on a position of an input key included in a skin of the user terminal.

The streaming server may manage a shared resource available to the user terminal based on control of the game content.

The controller may control an event of the game content corresponding to an input event of the service request.

The providing unit may stream and provide the result screen to an input screen of the user terminal.

According to an aspect of the present invention, there is provided a user terminal including a playback unit to play a result screen of game content of a streaming server corresponding to a service request transmitted to a cloud service providing apparatus, and a generation unit to generate a service request to control the game content based on the result screen using a skin displayed on the result screen.

The playback unit may play the result screen with the game content controlled based on a service request retransmitted to the cloud service providing apparatus.

The skin may be defined with an input key used by a user and a position of the input key designated on a screen of the user terminal as a script and be downloaded from the cloud service providing apparatus.

The generation unit may generate a service request including an input event for controlling the game content based on a touched position by a user on the skin of the user terminal.

According to an aspect of the present invention, there is provided a method of providing a cloud service, the method including allocating a streaming service providing a service to a user terminal corresponding to a service request for manipulating game content received from the user terminal, controlling the game content of the allocated streaming server based on the service request, and streaming and providing a result screen of the controlled game content to the user terminal, wherein the controlling of the game content controls the game content of the allocated streaming server based on a service request re-received from the user terminal provided with the result screen.

The allocating may allocate a streaming server including an application program used to manipulate the game content.

The service request may include an input event from a user for manipulating the game content based on a position of an input key comprised in a skin of the user terminal.

The streaming server may manage a shared resource available to the user terminal based on control of the game content.

The controlling may control an event of the game content corresponding to an input event of the service request.

The providing may stream and provide the result screen to an input screen of the user terminal.

According to an aspect of the present invention, there is provided a cloud service providing method of a user terminal, the method including playing a result screen of game content of a streaming server corresponding to a service request transmitted to a cloud service providing apparatus, and generating a service request to control the game content based on the result screen using a skin displayed on the result screen.

The playing may play the result screen with the game content controlled based on a service request retransmitted to the cloud service providing apparatus.

The skin may be defined with an input key used by a user and a position of the input key designated on a screen of the user terminal as a script and be downloaded from the cloud service providing apparatus.

The generating may generate a service request including an input event for controlling the game content based on a touched position by a user on the skin of the user terminal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a cloud service providing apparatus according to an exemplary embodiment;

FIG. 2 illustrates a detailed configuration of a cloud service providing apparatus according to an exemplary embodiment;

FIG. 3 illustrates a detailed configuration of a user terminal according to an exemplary embodiment;

FIG. 4 illustrates a detailed configuration of a cloud service providing apparatus actually implemented according to an exemplary embodiment;

FIG. 5 illustrates a detailed configuration of a streaming server actually implemented according to an exemplary embodiment;

FIG. 6 illustrates a detailed configuration of a user terminal actually implemented according to an exemplary embodiment;

FIG. 7 illustrates an input environment according to an exemplary embodiment; and

FIG. 8 illustrates a cloud service providing method according to an exemplary embodiment.

### DETAILED DESCRIPTION

Hereinafter, exemplary embodiments of the present invention will be described in detail with reference to the accompanying drawings.

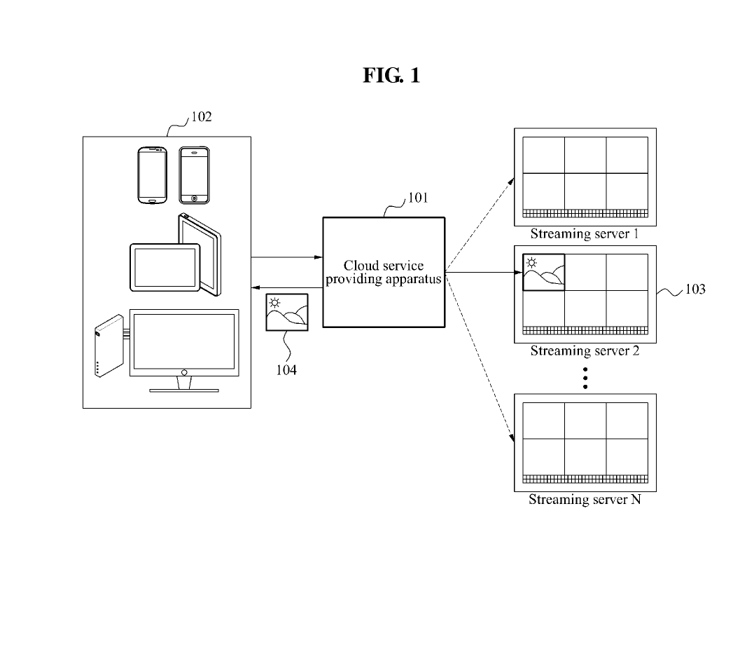

FIG. 1 illustrates a cloud service providing apparatus 101 according to an exemplary embodiment.

Referring to FIG. 1, the cloud service providing apparatus 101 may provide high-performance game content to a user terminal 102 by utilizing cloud computing. In detail, the cloud service providing apparatus 101 may perform rendering on game content requiring high performance at a service request of the user terminal 102 and provide a result screen 104 of the rendered game content to the user terminal 102. Here, the game content may be content on a game requiring high performance based on streaming, which may be content about an application program of a game that a user uses. The game content may be installed in a streaming server, not in the user terminal.

The user terminal 102 may include a terminal that needs high-performance graphics and rendering with low specifications or a terminal including limited hardware and software configurations. For example, the user terminal 102 may include a smart phone, a tablet, an Internet Protocol television (IPTV) set-top box, a TV and a tablet personal computer (PC).

Further, the cloud service providing apparatus 101 may be a device which may be linked with different user terminals 102 based on streaming. The cloud service providing apparatus 101 may provide a cloud service. The cloud service providing apparatus 101 may include a streaming server to provide a service to different user terminals 102. The streaming server is a streaming server node to provide different levels of image quality for being linked with the different user terminals 102, which may be a computing cloud including the streaming server node.

The cloud service providing apparatus 101 may allocate a streaming server 2 103 to the user terminal 102 in response to a service request from the user terminal 102. Here, the cloud service providing apparatus 101 may allocate the streaming server 2 103 to provide a service upon a service request.

The cloud service providing apparatus 101 may control game content of the allocated streaming server 2 103 based on a service request. Here, the service request may include an input event from the user for manipulating the game content based on a location of an input key included in a skin displayed on the user terminal. Further, the cloud service providing apparatus 101 may control an event of the game content of the streaming server based on the input event. The input event may be an event for controlling the game content of the streaming server in the same way as a game operation performed on the user terminal. For instance, the cloud service providing apparatus 101 may control a “go to shop” event of the game content of the streaming server corresponding to an input event “go to shop.” Further, the input event may be mapped onto an event of the game content of the streaming server according to a game operation. For instance, the cloud service providing apparatus 101 may control an event “go to shop in cloud village” of the game content of the streaming server mapped onto an input event “go to shop A.”

The cloud service providing apparatus 101 may stream and provide a result screen 104 of the controlled game content to the user terminal 102. The result screen 104 may be an input screen of the user terminal 102.

The user terminal 102 may play the result screen of the game content of the streaming server in response to a service request transmitted to the cloud service providing apparatus 101. The user terminal 102 may generate a service request for controlling the result screen using the skin disposed on the result screen. Here, the service request may be an event for controlling the game content of the streaming server based on a touched position by the user on the skin of the user terminal. The skin may be defined with an input key used by the user and a position of the input key designated on a screen of the user terminal as a script. The skin may be downloaded from the cloud service providing apparatus 101.

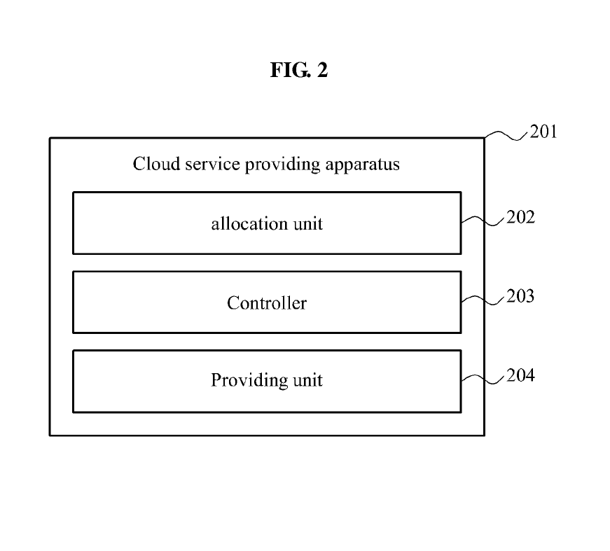

FIG. 2 illustrates a configuration of a cloud service providing apparatus 201 according to an exemplary embodiment.

Referring to FIG. 2, the cloud service providing apparatus 201 may include an allocation unit 202, a controller 203 and a providing unit 204.

The allocation unit 202 may receive a service request for manipulating game content from a user terminal. The service request may include an input event from a user for manipulating the game content based on a position of an input key included in a skin of the user terminal. Further, the service request may include an input event for controlling game content of a streaming server in the same way as a game operation performed on the user terminal. That is, the service request may include an input event based on an input key input by the user to control the game content of the streaming server. For instance, the service request may be an input event generated for executing a game of the game content.

The allocation unit 202 may allocate a streaming server to provide a service to the user terminal. Here, the streaming server may include an application program used to manipulate the game content. Here, the application program may refer to a game executable program or a game updating program needed to manipulate the game content. The streaming server may manage a shared resource based on manipulation of the game content. That is, the streaming server may manage a shared resources available to the user terminal according to control of the game content. The shared resource may include high-performance graphic resources, high-performance sound resources, and input and output devices. The streaming server may manage the shared resource available to the user terminal, thereby enabling efficient use of the shared resource according to service requests received from different user terminals.

The cloud service providing apparatus 201 may manage the shared resource available to the user terminal so as to efficiently control the game content requiring high-performance computing power or high costs according to service requests from user terminals connected at the same time.

That is, the allocation unit 202 may allocate the streaming server to provide a service to the user terminal corresponding to the service request for manipulating the game content received from the user terminal.

The controller 203 may control the game content of the allocated streaming server based on a service request. In detail, the controller 203 may control an event of the game content corresponding to an input event of the service request. Further, the controller 203 may control the event of the game content, including the shared resource available to the user terminal, based on the service request. For example, the controller 203 may execute a game based on the event of the game content corresponding to a service request to implement the game of the game content of the streaming server.

The controller 203 may control the shared resource and the event of the game content to use the high-performance game on the user terminal without a separate device. That is, the controller 203 may control graphics, sounds and events used by the user to implement the game in the streaming server, thereby enabling use of the high-performance game on the user terminal without a separate device. For example, the controller 203 executes the game of the game content upon a service request, thereby implementing the game on the user terminal with low specifications using computing power at a level for playing a video of a game requiring high-performance hardware. Here, the computing power may include electric power and specifications of a shared resource used to execute the game. The controller 203 may control the game content of the streaming server in the same way as a game operation performed on the user terminal.

The providing unit 204 may stream and provide a result screen of the controlled game content to the user terminal. Here, the result screen may be the same as an input screen of the user terminal. The result screen may be a result of controlling an event of the game content of the streaming server corresponding to an input event occurring on the input screen of the user terminal. The providing unit 204 may capture the result screen in real time, encode and provide the result screen to the user terminal.

The cloud service providing apparatus 201 may control the game content of the allocated streaming server based on a service request received again from the user terminal providing the result screen. For example, the cloud service providing apparatus 201 may execute the game based on a service request to implement the game of the game content.

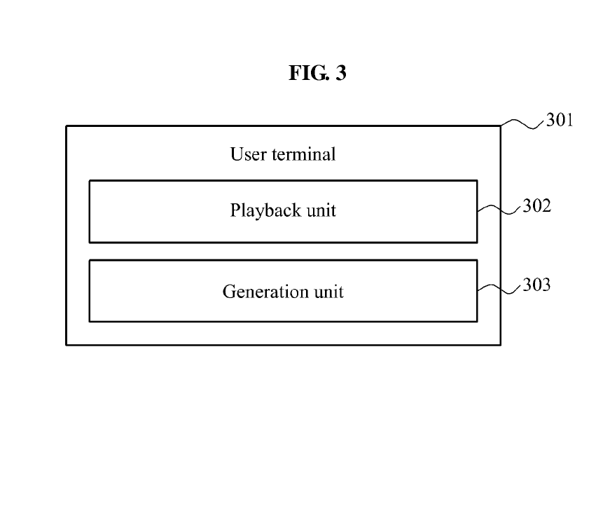

FIG. 3 illustrates a configuration of a user terminal 301 according to an exemplary embodiment in detail.

Referring to FIG. 3, the user terminal 301 may include a playback unit 302 and a generation unit 303.

The playback unit 302 may play the result screen of the game content of the streaming server corresponding to a service request transmitted to the cloud service providing apparatus. The playback unit 302 may play the result screen without linking with an additional input device. That is, the playback unit 302 may decode and play the result screen received from the cloud service providing apparatus based on streaming. The playback unit 302 may include a streaming-based playback module to stream and play the result screen in real time without a separate device. For example, the playback unit 302 may play the result screen of the game implemented via the game content in real time. The playback unit 302 may play the result screen of the game in real time on the user terminal, thereby playing the result screen including reactions as if the game is executed on the user terminal.

The generation unit 303 may generate a service request for controlling the game content based on the result screen using a skin displayed on the result screen. In detail, the generation unit 303 may generate a service request including an input event for controlling the game content based on a touched position by the user on the skin of the user terminal. The skin may be defined with an input key used by the user and a position of the input key designated on a screen of the user terminal as a script and may be downloaded from the cloud service providing apparatus. Here, the input key may include direction keys, attack keys and defense keys for playing the game. The position of the input key designated on the screen of the user terminal may be a location where the result screen is hidden on the limited screen of the user terminal.

The skin may be for processing various inputs in different input environments of user terminals. That is, the user terminal may include an input environment of a touchscreen or limited input keys, different from an input unit of a PC. For example, the input environment or limited input keys may refer to a keyboard input environment of a touch-based user terminal. When this input environment or these limited input keys are used in the user terminal, the result screen may be hidden by an input environment or input key. Moreover, the user terminal may have difficulty in generating an event request for executing the game subsequent to the result screen. Thus, the cloud service providing apparatus may provide a skin with an input key and a input position defined to the user, thereby overcoming problems due to the input environment or input key.

The user terminal may play the result screen with the controlled game content based on the service request retransmitted to the cloud service providing apparatus. For example, the user terminal may play the high-performance game in real time through the streaming server in response to a service request input from the user.

Also, the user terminal may be linked with the cloud service providing apparatus, thereby conveniently using the high-performance game content without an additional device.

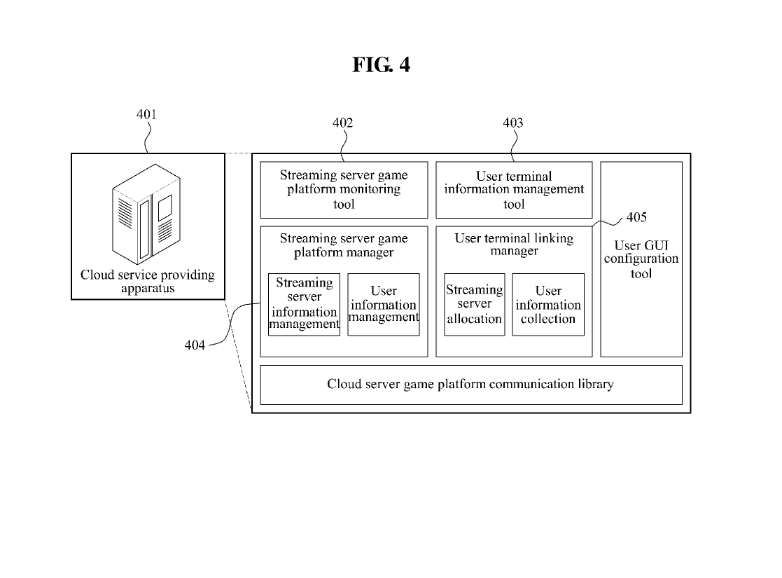

FIG. 4 illustrates a detailed configuration of a cloud service providing apparatus 401 actually implemented according to an exemplary embodiment.

Referring to FIG. 4, the cloud service providing apparatus 401 may include a streaming server to provide different levels of image quality for linking with various types of user terminals. The cloud service providing apparatus 401 may allocate an appropriate streaming server according to a service request from a user terminal.

The cloud service providing apparatus 401 may include a streaming server game platform monitoring tool 402, a user terminal information management tool 403, a streaming server game platform manager 404, and a user terminal linking manager 405.

The streaming server game platform monitoring tool 402 may manage a computing environment including a plurality of streaming servers. The streaming server game platform monitoring tool 402 may monitor a game platform of the streaming server. Further, the streaming server game platform monitoring tool 402 may receive a shared resource available to the user terminal from the streaming server to manage a computing environment of the game platform. Thus, the streaming server game platform monitoring tool 402 may receive the shared resource to collectively manage a state of the game platform.

The streaming server game platform manager 404 may manage streaming server information and user information. Here, the streaming server game platform manager 404 constructs a database of the streaming server information and the user information for management. The streaming server information may include information to verify whether the streaming server is allocated based on a service request received from the user terminal and basic information on the streaming server. The user information may include information on the user terminal allocated the streaming server and using the streaming server.

The user terminal information management tool 403 may manage information on a user terminal connecting to the cloud service providing apparatus 401. That is, the user terminal information management tool 403 may manage basic information for allocating an appropriate streaming server in response to a service request from the connected user terminal.

The user terminal linking manager 405 may allocate a streaming server or collect user information. In detail, the user terminal linking manager 405 may allocate a streaming server to provide a service to a user terminal based on a service request received from the user terminal. Further, the user terminal linking manager 405 may collect information on a user of the user terminal allocated the streaming server.

The cloud service providing apparatus 401 may provide a user interface (UI) for managing a service user and monitoring a state of a streaming server through a user graphic user interface (GUI) configuration tool so that an administrator effectively monitors and manages the game platform. In addition, the cloud service providing apparatus 401 may be linked with the streaming server through a cloud server game platform communication library.

The cloud service providing apparatus 401 may include a variety of streaming servers corresponding to different types of user terminals, thereby providing a streaming service related to high-performance games through a network regardless of performance and kinds of user terminals.

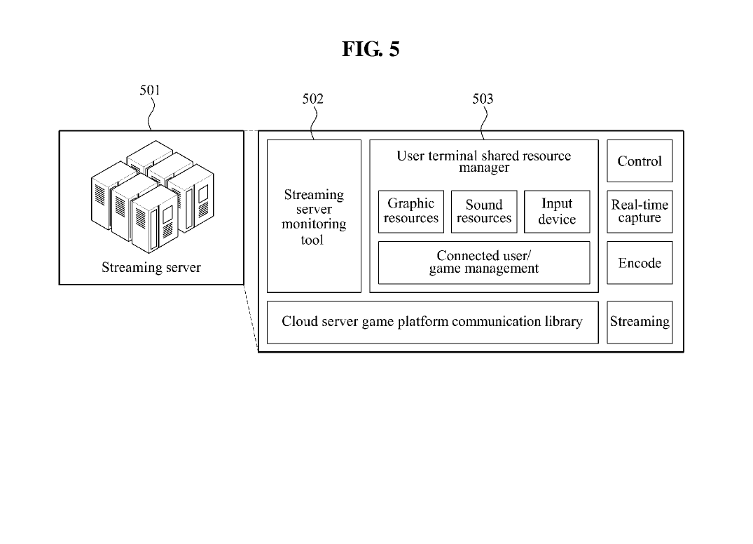

FIG. 5 illustrates a detailed configuration of a streaming server 501 actually implemented according to an exemplary embodiment.

Referring to FIG. 5, the streaming server 501 may be linked with a user terminal. Here, the streaming server 501 may be a server to provide a service to the user terminal in response to a service request from the user terminal. The streaming server 501 may implement an event of game content based on a service request. That is, the streaming server 501 may actually implement a game of the game content based on the service request.

The streaming server 501 may include a streaming server monitoring tool 502 and a user terminal shared resource manager 503.

The streaming server monitoring tool 502 may monitor a state of the streaming server.

The user terminal shared resource manager 503 may monitor a shared resource available to the user terminal. The user terminal shared resource manager 503 may periodically monitor the shared resource. The user terminal shared resource manager 503 may manage shared resources, such as graphic resources, sound resources and an input device. Further, the user terminal shared resource manager 503 may manage a game implemented by a user connected to the user terminal connected to the streaming server. The user terminal shared resource manager 503 may manage the shared resources such that no collision occur between a plurality of connected user terminals in sharing server resources.

The user terminal shared resource manager 503 may transmit the monitored shared resource to a streaming server providing apparatus. The user terminal shared resource manager 503 transmits the shared resource to the streaming server providing apparatus, thereby supporting the streaming server providing apparatus in collectively managing a state of the game platform of the streaming server. Here, the user terminal shared resource manager 503 may be linked with the cloud service providing apparatus through a cloud server game platform communication library.

The streaming server 501 may control the event of the game content in response to a service request received from the user terminal. Here, the control means actually implementing a game present in the server according to an input event of the service request. The streaming server 501 may implement a high-performance game, which is not performed on the user terminal with low specifications, in the streaming server and capture a result screen of implementation in real time. The streaming server 501 may encode the captured result screen to be played on the user terminal. The streaming server 501 may stream and provide the encoded result screen to the user terminal.

Here, the streaming server 501 may regenerate an event of the game content of the streaming server 501 based on the provided result screen in response to a service request retransmitted from the user terminal.

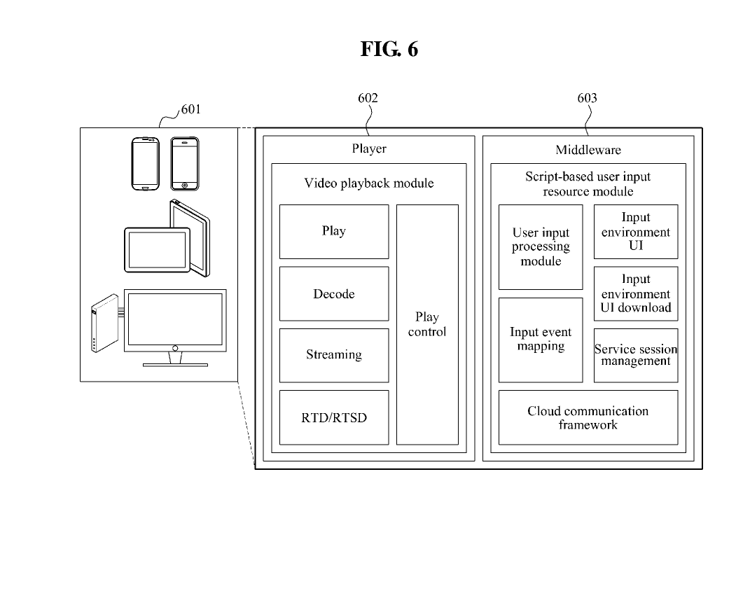

FIG. 6 illustrates a detailed configuration of a user terminal actually implemented according to an exemplary embodiment.

Referring to FIG. 6, the user terminal 601 may play a result screen with respect to a service request from a cloud service providing apparatus. The user terminal 601 may generate a service request from a user for controlling the game content based on the result screen. The user terminal 601 may include a player 602 and middleware 603 for providing a service without linking with an additional input or output device.

The player 602 may play the result screen received from the cloud service providing apparatus. The player 602 may decode and play the result screen based on an input event of a game. Here, the player 602 may decode a result screen of streaming. The player 602 may play a result screen of streaming the game in real time, thereby playing the game as if the game is implemented on the user terminal.

In detail, the player 602 may include a video playback module of a streaming block, a decoding block and a play block to play the result screen. Each block may be capsulated in a linking interface to ease separation and linking. Accordingly, multiplatform support may be facilitated using only a needed block in optimizing and upgrading hardware and system software. Here, multiplatform support means supporting various user terminals to perform a high-performance game regardless of performance or kinds of user terminals.

The player 602 may play the result screen of implementation in the streaming server on various user terminals, thereby supporting the user terminals in implementing a high-performance game without an additional device.

The middleware 603 may process an input key input from the user via a user input processing module. Here, the user may input the input key through a skin displayed on the result screen. The middleware 603 may map an input event onto the input key on the skin. In detail, the middleware 603 may map the input key input from the user onto an input event to implement the input key in an actual game or on the user terminal.

The skin may be for processing various inputs in different input environments of user terminals. That is, the skin may include a specialized input screen based on characteristics of games in order to overcome a problem of hiding the screen result by limited input keys of a PC or an input unit of a touchscreen. The skin may be disposed properly on a screen of the user terminal. In detail, the skin may be provided through an input environment UI. The input environment UI may analyze an input key defined as a script and a position of the input key disposed on the screen of the user terminal, thereby configuring a specialized skin. The skin may be a game input menu skin.

The skin may be downloaded through an input environment UI download. The input environment UI download may download the skin from the cloud service providing apparatus.

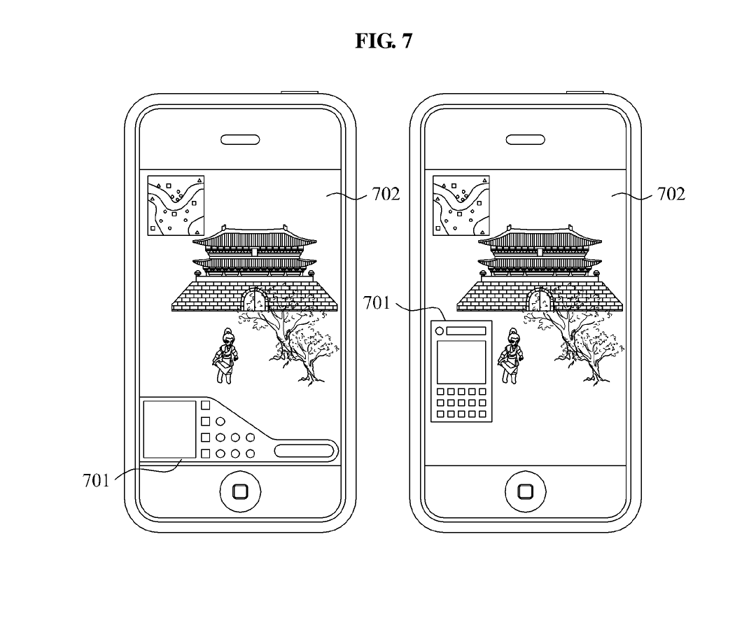

FIG. 7 illustrates an input environment according to an exemplary embodiment.

Referring to FIG. 7, a skin may be implemented through a cloud service providing apparatus or a separate server to realize a skin. In detail, the skin may be realized by the streaming server defining an input key to use and designating a position of the input key on an input screen. The realized skin may be automatically stored as a script.

The user may download and use a desired skin in real time.

Further, an input key input through the skin may be mapped onto an actual game or an input event to be implemented on the user terminal.

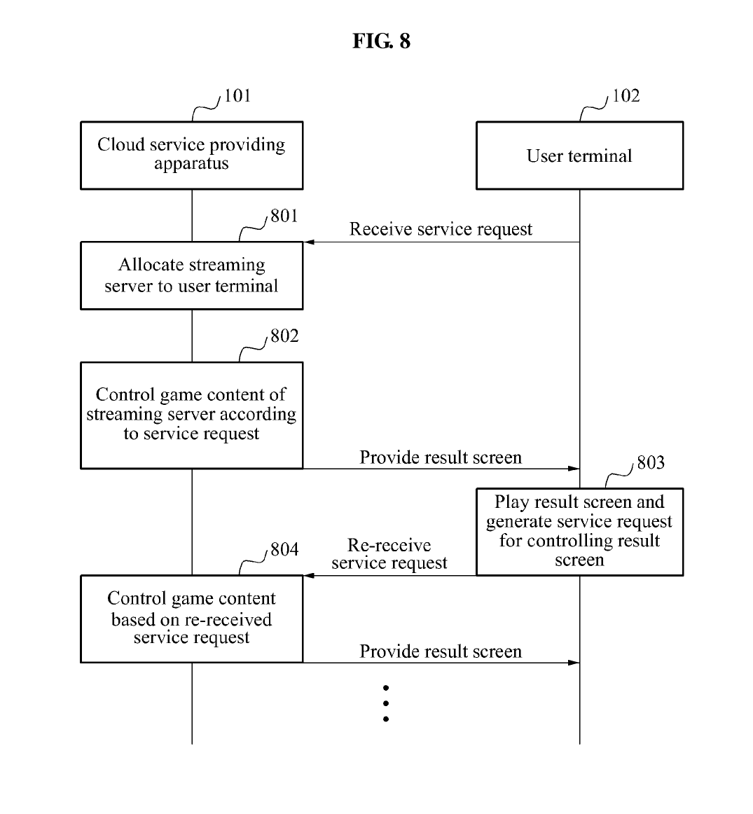

FIG. 8 illustrates a cloud service providing method according to an exemplary embodiment.

In operation 801, the cloud service providing apparatus 101 may receive a service request for manipulating game content from a user terminal. The cloud service providing apparatus 101 may allocate a streaming server to provide a service to the user terminal. Here, the streaming server may include an application program used to manipulate the game content.

In operation 802, the cloud service providing apparatus 101 may control the game content of the allocated streaming server based on a service request. In detail, the cloud service providing apparatus 101 may control an event of the game content corresponding to an input event of the service request. That is, the cloud service providing apparatus 101 may control graphics, sounds and events used by the user to implement a game in the streaming server, thereby enabling use of the high-performance game on the user terminal without a separate device. Also, the cloud service providing apparatus 101 may control the game content of the streaming server in the same way as a game operation performed on the user terminal.

The cloud service providing apparatus 101 may stream and provide a result screen of the controlled game content to the user terminal. The result screen may be an input screen of the user terminal.

In operation 803, the user terminal 102 may play the result screen of the game content of the streaming server corresponding to a service request transmitted to the cloud service providing apparatus. The user terminal 102 may decode and play the result screen without linking with an additional input device.

The user terminal 102 may generate a service request for controlling the game content based on the result screen using a skin displayed on the result screen. In detail, the user terminal 102 may generate a service request including an input event for controlling the game content based on a touched position by the user on the skin of the user terminal.

In operation 804, the cloud service providing apparatus 101 may control an event of the game content according to a service request received again from the user terminal 102. The cloud service providing apparatus 101 may provide a result screen of the game content controlled based on the received service request to the user terminal.

The user terminal 102 may play the result screen with the controlled game content based on the service request retransmitted to the cloud service providing apparatus.

The foregoing methods according to the exemplary embodiments of the present invention may be recorded in non-transitory computer-readable media including program instructions to implement various operations embodied by a computer. The media may also include, alone or in combination with the program instructions, data files, data structures, and the like. The program instructions recorded in the media may be designed and configured specially for the present invention or be known and available to those skilled in computer software.

As described above, a cloud service providing apparatus according to an exemplary embodiment enables efficient use of cloud computing on a user terminal with low specifications by minimizing delays in encoding, decoding and networking of an image so as to provide a service on streaming-based high-performance content in real time.

A cloud service providing apparatus according to an exemplary embodiment provides an exclusive input interface for use of game content requiring high-performance graphics and rendering on a user terminal with low specifications, thereby conveniently utilizing the game content on user terminals including different interfaces without an additional device.

A cloud service providing apparatus according to an exemplary embodiment provides a streaming-based cloud server to be applied to a user terminal with low specifications, thereby enabling a single platform-based application service to be available on various platforms.

A cloud service providing apparatus according to an exemplary embodiment installs an application program of a game platform used by a user on a streaming server, not on a user terminal, thereby efficiently providing a streaming-based service regardless of performance.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention.

Therefore, the scope of the present invention is not limited to the foregoing exemplary embodiments but is defined by the claims and their equivalents.

The skin is defined with an input key used by a user and a position of the input key designated on a screen of the user terminal as a script and downloaded from the cloud service providing apparatus.

The generating generates a service request comprising an input event for controlling the game content based on a touched position by a user on the skin of the user terminal

What is claimed is:

1. An apparatus for providing a cloud service, the apparatus comprising:
an allocation unit to allocate a streaming service providing a service to a user terminal corresponding to a service request for manipulating game content received from the user terminal;
a controller to control the game content of the allocated streaming server based on the service request; and
a providing unit to stream and provide a result screen of the controlled game content to the user terminal,
wherein the controller controls the game content of the allocated streaming server based on a service request re-received from the user terminal provided with the result screen.

2. The apparatus of claim 1, wherein the allocation unit allocates a streaming server comprising an application program used to manipulate the game content.

3. The apparatus of claim 1, wherein the service request comprises an input event from a user for manipulating the game content based on a position of an input key comprised in a skin of the user terminal.

4. The apparatus of claim 1, wherein the streaming server manages a shared resource available to the user terminal based on control of the game content.

5. The apparatus of claim 1, wherein the controller controls an event of the game content corresponding to an input event of the service request.

6. The apparatus of claim 1, wherein the providing unit streams and provides the result screen to an input screen of the user terminal.

7. A user terminal comprising:
a playback unit to play a result screen of game content of a streaming server corresponding to a service request transmitted to a cloud service providing apparatus; and
a generation unit to generate a service request to control the game content based on the result screen using a skin displayed on the result screen.

8. The user terminal of claim 7, wherein the playback unit plays the result screen with the game content controlled based on a service request retransmitted to the cloud service providing apparatus.

9. The user terminal of claim 7, wherein the skin is defined with an input key used by a user and a position of the input key designated on a screen of the user terminal as a script and downloaded from the cloud service providing apparatus.

10. The user terminal of claim 7, wherein the generation unit generates a service request comprising an input event for controlling the game content based on a touched position by a user on the skin of the user terminal.

11. A method of providing a cloud service, the method comprising:
allocating a streaming service providing a service to a user terminal corresponding to a service request for manipulating game content received from the user terminal;
controlling the game content of the allocated streaming server based on the service request; and
streaming and providing a result screen of the controlled game content to the user terminal,
wherein the controlling of the game content controls the game content of the allocated streaming server based on a service request re-received from the user terminal provided with the result screen.

12. The method of claim 11, wherein the allocating allocates a streaming server comprising an application program used to manipulate the game content.

13. The method of claim 11, wherein the service request comprises an input event from a user for manipulating the game content based on a position of an input key comprised in a skin of the user terminal.

14. The method of claim 11, wherein the streaming server manages a shared resource available to the user terminal based on control of the game content.

15. The method of claim 11, wherein the controlling controls an event of the game content corresponding to an input event of the service request.

16. The method of claim 11, wherein the providing streams and provides the result screen to an input screen of the user terminal.
